(19) United States
(12) Patent Application Publication
(10) Pub. No.: US 2015/0278733 A1
(43) Pub. Date: Oct. 1, 2015

(54) METHOD AND SYSTEM FOR REPORTING EVENTS AND CONDITIONS

(71) Applicant: Florida Power & Light Company, Juno Beach, FL (US)

(72) Inventors: Annamalai Lakshmanan, Stuart, FL (US); Carlos Sua, Palm Beach Gardens, FL (US); Kevin M. O'Donnell, Wellington, FL (US); Anthony DiRocco, Juno Beach, FL (US); Roemer Ricardo, Plantation, FL (US); Juan Henry, Palm Beach Gardens, FL (US)

(21) Appl. No.: 14/675,083

(22) Filed: Mar. 31, 2015

Related U.S. Application Data
(60) Provisional application No. 61/972,984, filed on Mar. 31, 2014.

(51) Int. Cl. G06Q 10/06; H04W 4/02

(52) U.S. Cl. CPC G06Q 10/06312; G06Q 10/0635; H04W 4/028

(57) ABSTRACT

A system for reviewing, surveying, and maintaining a facility or other area may include one or more mobile devices and a central computer processing unit. A computer software program may be operating on the one or more mobile devices. Using the software and the one or more mobile devices, one or more users may collect data and observations about events occurring at the facility, such as unsafe conditions of the facility or nearly catastrophic events. Maintenance may be scheduled, and reports may be generated, using the event data collected.

### CROSS REFERENCE TO RELATED APPLICATIONS

This application claims the benefit of U.S. Provisional Application No. 61/972,984 filed Mar. 31, 2014, the disclosure of which is hereby incorporated herein by reference in its entirety.

### FIELD OF THE DISCLOSURE

The present disclosure relates to the field of applications for portable multifunction devices such as tablets or smart phones. More specifically, the disclosure relates to the use of portable multifunction devices to report unsafe condition events.

### BACKGROUND OF THE DISCLOSURE

In the course of their employment, employees of a utility company are often tasked with investigating unsafe conditions at various utility structures or facilities, such as power generation plants. In the course of their inspection, employees may observe “near miss events” which may be pre-cursor events to more dangerous events, such as catastrophic failure of a structure of machine. Conventionally, the investigator would tour a facility and take notes of unsafe conditions or near miss events. The investigator may record his notes through manually entry into a computer system having a database. Work commitments, time constraints, or other similar reasons may result in the investigator forgetting to enter his notes into a computer. As a result, further investigation, analysis, or preventive maintenance on the facility may not be performed. Thus, by relying on conventional note-taking to investigate and document unsafe conditional and near miss events, utilities and other facilities operators may run the risk of increased exposure due to otherwise avoidable accidents had the near miss event been properly documented.

### SUMMARY OF THE DISCLOSURE

The following presents a simplified summary of the disclosure in order to provide a basic understanding of some aspects of the invention. This summary is not an extensive overview of the various embodiments disclosed herein. It is intended to neither identify key or critical elements of the embodiments nor delineate the scope of the embodiments. Its sole purpose is to present some concepts of the disclosure in a simplified form as a prelude to the more detailed description that is presented later.

In one embodiment of the disclosure, a system for reporting events or conditions of a facility may be composed of a mobile device including a device processor, a device transmitter, and a device receiver, as well as a central computer including a central process, a central database, a central transmitter, and a central receiver. The mobile device may collect event data inputted by a user of the mobile device and transmit the event data transmitter to the central receiver. The central processor may generate a report categorizing and describing the event data. The event data may include observations by the user of an event at the facility requiring maintenance of the facility.

In another embodiment, a non-transitory computer-readable medium within a mobile device for reviewing conditions of a facility, may include instructions stored thereon that when executed on a processor perform a plurality of steps. Those steps may include collecting information about an event associated with a facility, the information may including the type of event, the location of the event, when the event occurred, and whether follow up action is required. The steps may further include storing the information in a database provided in the mobile device, and transmitting the information from a transmitter provided in the mobile device to a receiver provided in a central computer processing unit.

The following description and the annexed drawings set forth certain illustrative aspects of embodiments of the disclosure. These aspects are indicative, however, of but a few of the various ways in which the principles of the disclosure may be employed and the disclosed embodiments are intended to include all such aspects and their equivalents. Other advantages and novel features of the embodiments disclosed herein will become apparent from the following description when considered in conjunction with the drawings.

### BRIEF DESCRIPTION OF THE DRAWINGS

FIGS. 1 and 2 illustrate block diagrams of an embodiment of a portable multifunction devices with touch-sensitive displays;

FIG. 3 illustrates an embodiment of a graphical user interface as part of an embodiment of a computer software application operating on a mobile device, the interface showing a screen for selecting an event category;

FIG. 4 illustrates an embodiment of a graphical user interface as part of an embodiment of a computer software application operating on a mobile device, the interface showing a home screen;

FIG. 5 illustrates an embodiment of a graphical user interface as part of an embodiment of a computer software application operating on a mobile device, the interface showing a screen for collecting new event information;

FIG. 6 illustrates an embodiment of a graphical user interface as part of an embodiment of a computer software application operating on a mobile device, the interface showing an extension of the screen of FIG. 5 for collecting new event information;

FIG. 7 illustrates an embodiment of a graphical user interface as part of an embodiment of a computer software application operating on a mobile device, the interface showing an additional screen for collecting new event information;

FIG. 8 illustrates an embodiment of a graphical user interface as part of an embodiment of a computer software application operating on a mobile device, the interface showing a menu screen for saving new event information;

FIG. 9 illustrates an embodiment of a graphical user interface as part of an embodiment of a computer software application operating on a mobile device, the interface showing an additional menu screen for saving new event information;

FIG. 10 illustrates an embodiment of a graphical user interface as part of an embodiment of a computer software application operating on a mobile device, the interface showing an uploading event information screen;

FIG. 11 illustrates an embodiment of a graphical user interface as part of an embodiment of a computer software application operating on a mobile device, the interface showing a voice manager screen;

FIG. 12 illustrates an embodiment of a graphical user interface as part of an embodiment of a computer software application operating on a mobile device, the interface showing an additional menu screen;

FIG. 13 illustrates an embodiment of a graphical user interface as part of an embodiment of a computer software application operating on a mobile device, the interface showing an previously completed event screen;

FIG. 14 illustrates an embodiment of a graphical user interface as part of an embodiment of a computer software application operating on a central computer, the interface showing a report generated from previously completed events; and

FIG. 15 illustrates a schematic of system architecture in accordance with an embodiment of the disclosure.

### DETAILED DESCRIPTION OF DISCLOSURE

Reference will now be made in detail to embodiments, examples of which are illustrated in the accompanying drawings. The following description refers to the accompanying drawings, in which, in the absence of a contrary representation, the same numbers in different drawings represent similar elements. The implementations set forth in the following description do not represent all implementations consistent with the claims. Instead, they are merely some examples of systems and methods consistent with certain aspects related to the embodiments disclosed.

In one embodiment of the disclosure, a system for reporting events or conditions of a facility may be composed of a mobile device including a device processor, a device transmitter, and a device receiver, as well as a central computer including a central process, a central database, a central transmitter, and a central receiver. The mobile device may collect event data inputted by a user of the mobile device and transmit the event data transmitter to the central receiver. The central processor may generate a report categorizing and describing the event data. The event data may include observations by the user of an event at the facility requiring maintenance of the facility. Embodiments of applications executed by portable multifunction devices, user interfaces for such devices, and associated processes for using such devices are described. In some embodiments, the device is a portable communications device such as a mobile telephone that also contains other functions, such as PDA and/or music player functions.

In further embodiments, the event data may include whether the event requires follow up maintenance, and the central processor may generate a maintenance schedule which may include whether the event requires follow up maintenance, and may transmit the maintenance schedule from the central transmitter to the device receiver. The maintenance schedule may include a plurality of events requiring follow up maintenance and generates a service route for the user to follow in order for the user to efficiently observe each location of the plurality of events. The mobile device may include a global positioning system (GPS) module and the device processor may further identify the location of the user and adjust the generated service route based on the user's location.

Embodiments of the system may further include an additional mobile device having a second device processor, a second device transmitter, and a second device receiver, and the additional mobile device may collect event data inputted by an additional user of the additional mobile device and transmit the event data from the second device transmitter to the central processor. The event data may include whether the event requires follow up maintenance, and the central processor may further generate a maintenance schedule which may include a plurality of events requiring follow up maintenance, and may transmit the maintenance schedule from the central transmitter to the device receiver and the second device receiver. The device process and the second device processor may each respectively compare the location of the each of the plurality of events requiring follow up maintenance and generate a service route for the users to follow in order for the users to efficiently observe each location of the plurality of events. The mobile device may further include a global positioning system (GPS) module and the additional mobile device may further include a second global positioning system (GPS) module. The device processor may further identify the location of the user of the mobile device and the second device processor may further identify the location of the user of the second mobile device, and the device processor and second device processor each adjust the service routes based on each user's location. The adjusted service routes may be transmitted to the central processor, which may compare the adjusted service route of the first user with the adjusted service route of the second user, determine if there is any overlap between the adjusted service routes, correct each of the adjusted service routes if there is overlap, and transmit the corrected routes to the mobile device and the additional mobile device.

In another embodiment, a non-transitory computer-readable medium within a mobile device for reviewing conditions of a facility, may include instructions stored thereon that when executed on a processor perform a plurality of steps. Those steps may include collecting information about an event associated with a facility, the information may including the type of event, the location of the event, when the event occurred, and whether follow up action is required. The steps may further include storing the information in a database provided in the mobile device, and transmitting the information from a transmitter provided in the mobile device to a receiver provided in a central computer processing unit.

In further embodiments, the information may include an attachment file of a picture of the event. The information may be collected from a user of the mobile device audibly inputting the data with a voice manager. The information also include user identification information, and a user of the mobile device may elect to transmit the information anonymously. The event may be an unsafe condition at the facility.

For simplicity, in the discussion that follows, a prior art portable multifunction device that includes a touch screen is used as an exemplary embodiment for executing the applications of the present invention. A prior art portable multifunction device such as an iPhone™ or the device disclosed in U.S. Pat. No. 7,479,949 can be used to execute the applications of the present invention. The applications can also be executed in portable multifunction devices that do not include a touch screen for inputting information, but that rely instead on a more conventional mechanism, for example point-and-click, keypad, keyboard, or click-wheel mechanisms.

In addition to supporting the applications of the present invention, the portable multifunction device described below can support a variety of applications, such as one or more of the following: a telephone application, a video conferencing application, an e-mail application, an instant messaging application, a blogging application, a photo management application, a digital camera application, a digital video camera application, a web browsing application, a digital music player application, and/or a digital video player application.

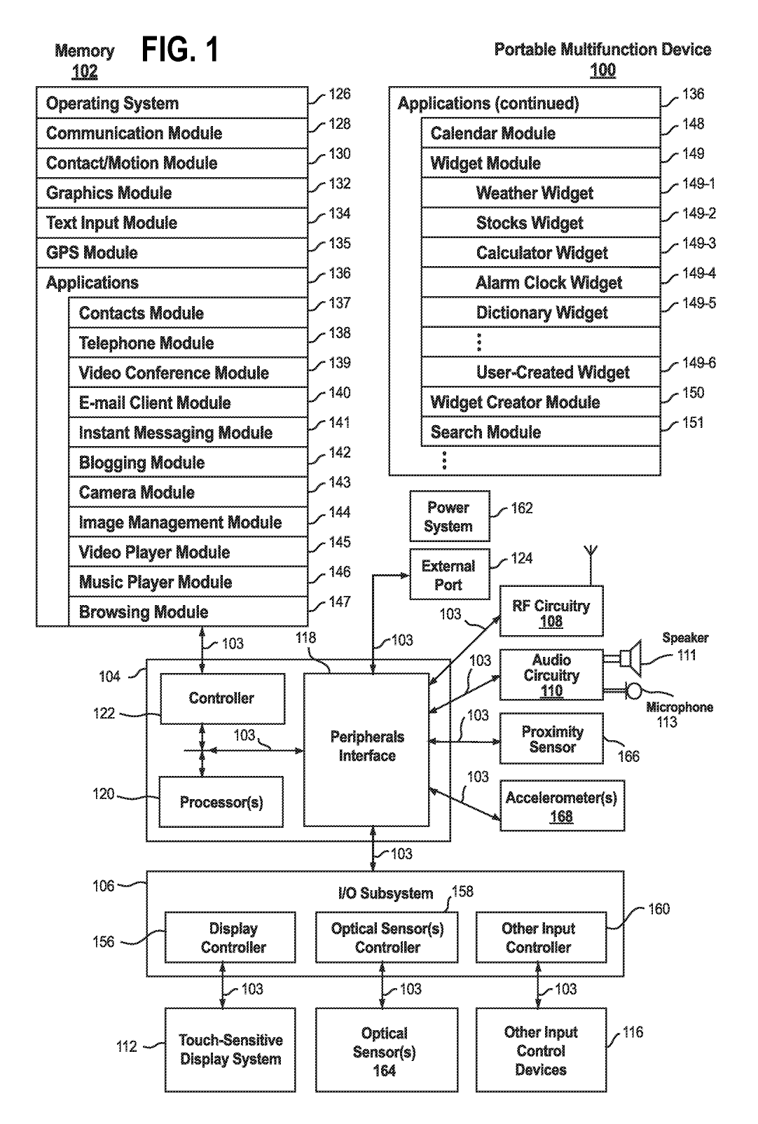

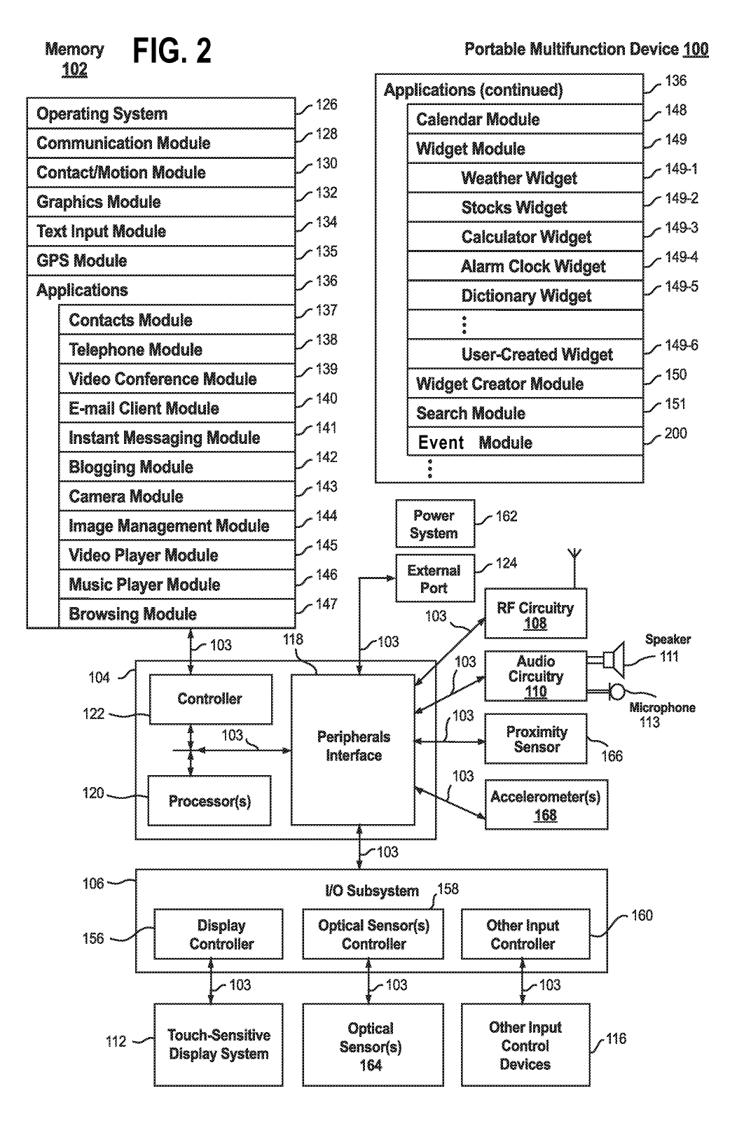

FIGS. 1 and 2 are block diagrams illustrating exemplary prior art portable multifunction devices 100 with touch-sensitive displays 112 modified to include the applications of the present invention. The touch-sensitive display 112 is also known in the art as a touch screen or a touch-sensitive display system. The device 100 may include a memory 102 (which may include one or more computer readable storage mediums), a memory controller 122, one or more processing units (CPU's) 120, a peripherals interface 118, RF circuitry 108, audio circuitry 110, a speaker 111, a microphone 113, an input/output (I/O) subsystem 106, other input or control devices 116, and an external port 124. The device 100 may include one or more optical sensors 164. These components may communicate over one or more communication buses or signal lines 103.

The device 100 is only one example of a portable multifunction device 100 that may be used to execute the applications of the present invention, and that the device 100 may have more or fewer components than shown, may combine two or more components, or a may have a different configuration or arrangement of the components. The various components shown in FIGS. 1 and 2 may be implemented in hardware, software or a combination of both hardware and software, including one or more digital signal processing (“DSP”) circuits and/or application specific integrated circuits (“ASICs”).

Memory 102 may include high-speed random access memory and may also include non-volatile memory, such as one or more magnetic disk storage devices, flash memory devices, or other non-volatile solid-state memory devices. Access to memory 102 by other components of the device 100, such as the CPU 120 and the peripherals interface 118, may be controlled by the memory controller 122.

The peripherals interface 118 couples the input and output peripherals of the device to the CPU 120 and memory 102. The one or more processors 120 run or execute various software programs and/or sets of instructions stored in memory 102 to perform various functions for the device 100 and to process data.

The peripherals interface 118, the CPU 120, and the memory controller 122 may be implemented on a single chip, such as a chip 104. They may also be implemented on separate chips.

The transceiver circuitry 108 receives and sends electromagnetic signals. A person of ordinary skill in the art would recognize that these signals are conventionally referred to as radio frequency (“RF”) signals in the context of portable devices, regardless of whether the signals fall within what is conventionally known as the radio spectrum. The term transceiver circuitry and RF circuitry will be used interchangeably in the present application.

The RF circuitry 108 converts electrical signals to/from electromagnetic signals and communicates information to and from communications networks and other communications devices by modulating/demodulating electromagnetic signals with data corresponding to the information. The RF circuitry 108 may include circuitry known in the art for performing these functions, including but not limited to an antenna system, one or more amplifiers, filters, a tuner, one or more oscillators, a digital signal processor, a CODEC chipset, modulator/demodulator, a subscriber identity module (SIM) card, memory, and so forth. The RF circuitry 108 may communicate with networks, such as the Internet, an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this application.

The audio circuitry 110, the speaker 111, and the microphone 113 provide an audio interface between a user and the device 100. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from sound waves. The audio circuitry 110 converts the electrical signal to audio data and transmits the audio data to the peripherals interface 118 for processing. Audio data may be retrieved from and/or transmitted to memory 102 and/or the RF circuitry 108 by the peripherals interface 118. The audio circuitry 110 may also include a headset jack. The headset jack provides an interface between the audio circuitry 110 and removable audio input/output peripherals, such as output-only headphones or a headset with both output (e.g., a headphone for one or both ears) and input (e.g., a microphone).

The I/O subsystem 106 couples input/output peripherals on the device 100, such as the touch screen 112 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 116 may include physical buttons (e.g., push buttons, rocker buttons, etc.), dials, slider switches, joysticks, click wheels, and so forth. Input controller(s) 160 may also be coupled to any (or none) of the following: a keyboard, infrared port, USB port, and a pointer device such as a mouse.

The touch-sensitive touch screen 112 provides an input interface and an output interface between the device and a user. The display controller 156 receives and/or sends electrical signals from/to the touch screen 112. The touch screen 112 displays visual output to the user. The visual output may include graphics, text, icons, video, and any combination thereof (collectively termed “graphics”).

A touch screen 112 has a touch-sensitive surface, sensor or set of sensors that accepts input from the user through tactile contact. The touch screen 112 and the display controller 156 (along with any associated modules and/or sets of instructions in memory 102) detect contact (and any movement or breaking of the contact) on the touch screen 112 and converts the detected contact into interaction with user-interface objects (e.g., one or more soft keys, icons, web pages or images) that are displayed on the touch screen. For example, a point of contact between a touch screen 112 and the user corresponds to a finger of the user.

The touch screen 112 may use LCD (liquid crystal display) technology, or LPD (light emitting polymer display) technology, although other display technologies may also be used. The touch screen 112 and the display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 112.

The device 100 also includes a power system 162 for powering the various components. The power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The device 100 may also include one or more optical sensors 164. FIGS. 1 and 2 show an optical sensor coupled to an optical sensor controller 158 in I/O subsystem 106. The optical sensor 164 may include charge-coupled device (CCD) or complementary metal-oxide semiconductor (CMOS) phototransistors. The optical sensor 164 receives light from the environment, projected through one or more lens, and converts the light to data representing an image. In conjunction with an imaging module 143 (also called a camera module), the optical sensor 164 may capture still images or video. The optical sensor may be located on the back of the device 100, opposite the touch screen display 112 on the front of the device, so that the touch screen display may be used as a viewfinder for either still and/or video image acquisition. An optical sensor may also be located on the front of the device so that the user's image may be obtained for videoconferencing while the user views the other video conference participants on the touch screen display. Preferably, the position of the optical sensor 164 can be changed by the user (e.g., by rotating the lens and the sensor in the device housing) so that a single optical sensor 164 may be used along with the touch screen display for both video conferencing and still and/or video image acquisition.

The device 100 may also include one or more proximity sensors 166. FIGS. 1 and 2 show a proximity sensor 166 coupled to the peripherals interface 118. Alternately, the proximity sensor 166 may be coupled to an input controller 160 in the I/O subsystem 106. The proximity sensor 166 may be used to turn off and disable the touch screen 112 when the multifunction device is placed near the user's ear (e.g., when the user is making a phone call). The proximity sensor can also be used to keep the screen off when the device is in the user's pocket, purse, or other dark area to prevent unnecessary battery drainage when the device is a locked state.

The device 100 may also include one or more accelerometers 168. FIGS. 1 and 2 show an accelerometer 168 coupled to the peripherals interface 118. Alternately, the accelerometer 168 may be coupled to an input controller 160 in the I/O subsystem 106. The accelerometer 168 captures data that is analyzed to determine whether to change a view of information, for example from portrait to landscape, displayed on the screen of the portable device.

The software components stored in memory 102 may include an operating system 126, a communication module (or set of instructions) 128, a contact/motion module (or set of instructions) 130, a graphics module (or set of instructions) 132, a text input module (or set of instructions) 134, a Global Positioning System (GPS) module (or set of instructions) 135, and applications (or set of instructions) 136.

The operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 128 facilitates communication with other devices over one or more external ports 124 and also includes various software components for handling data received by the RF circuitry 108 and/or the external port 124. The external port 124 (e.g., Universal Serial Bus (USB), FIREWIRE, etc.) is adapted for coupling directly to other devices or indirectly over a network (e.g., the Internet, wireless LAN, etc.).

The contact/motion module 130 may detect contact with the touch screen 112 (in conjunction with the display controller 156) and other touch sensitive devices (e.g., a touchpad or physical click wheel). The contact/motion module 130 includes various software components for performing various operations related to detection of contact, such as determining if contact has occurred, determining if there is movement of the contact and tracking the movement across the touch screen 112, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). Alternatively the contact/motion module 130 and the controller 160 detect contact on a click wheel, for example.

The graphics module 132 includes various known software components for rendering and displaying graphics on the touch screen 112, including components for changing the intensity of graphics that are displayed. As used herein, the term “graphics” includes any object that can be displayed to a user, including without limitation text, web pages, icons (such as user-interface objects including soft keys), digital images, videos, animations and the like.

The text input module 134, which may be a component of graphics module 132, provides soft keyboards for entering text in various applications (e.g., contacts 137, e-mail 140, IM 141, blogging 142, browser 147, and any other application that needs text input).

The GPS module 135 determines the location of the device and provides this information for use in various applications (e.g., to telephone 138 for use in location-based dialing, to camera 143 and/or blogger 142 as picture/video metadata, and to applications that provide location-based services such as weather widgets, local yellow page widgets, and map/navigation widgets).

The applications 136 may include the following modules (or sets of instructions), or a subset or superset thereof: a contacts module 137 (sometimes called an address book or contact list); a telephone module 138; a video conferencing module 139; an e-mail client module 140; an instant messaging (IM) module 141; a blogging module 142; a camera module 143 for still and/or video images; an image management module 144; a video player module 145; a music player module 146; a browser module 147; a calendar module 148; widget modules 149, which may include weather widget 149-1, stocks widget 149-2, calculator widget 149-3, alarm clock widget 149-4, dictionary widget 149-5, and other widgets obtained by the user, as well as user-created widgets 149-6; widget creator module 150 for making user-created widgets 149-6; search module 151; video and music player module 152, which merges video player module 145 and music player module 146; notes module 153; and/or map module 154; and/or online video module 155.

Examples of other applications 136 that may be stored in memory 102 include other word processing applications, JAVA-enabled applications, encryption, digital rights management, voice recognition, and voice replication.

In conjunction with touch screen 112, display controller 156, contact module 130, graphics module 132, and text input module 134, the contacts module 137 may be used to manage an address book or contact list, including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch screen 112, display controller 156, contact module 130, graphics module 132, and text input module 134, the telephone module 138 may be used to enter a sequence of characters corresponding to a telephone number, access one or more telephone numbers in the address book 137, modify a telephone number that has been entered, dial a respective telephone number, conduct a conversation and disconnect or hang up when the conversation is completed. As noted above, the wireless communication may use any of a plurality of communications standards, protocols and technologies.

In conjunction with RF circuitry 108, audio circuitry 110, speaker 111, microphone 113, touch screen 112, display controller 156, optical sensor 164, optical sensor controller 158, contact module 130, graphics module 132, text input module 134, contact list 137, and telephone module 138, the videoconferencing module 139 may be used to initiate, conduct, and terminate a video conference between a user and one or more other participants.

In conjunction with RF circuitry 108, touch screen 112, display controller 156, contact module 130, graphics module 132, and text input module 134, the e-mail client module 140 may be used to create, send, receive, and manage e-mail. In conjunction with image management module 144, the e-mail module 140 makes it easy to create and send e-mails with still or video images taken with camera module 143.

In conjunction with RF circuitry 108, touch screen 112, display controller 156, contact module 130, graphics module 132, and text input module 134, the near miss application module 201 may be used to report near miss and other events as will be described below.

In conjunction with RF circuitry 108, touch screen 112, display controller 156, contact module 130, graphics module 132, and text input module 134, the instant messaging module 141 may be used to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages.

In conjunction with RF circuitry 108, touch screen 112, display controller 156, contact module 130, graphics module 132, text input module 134, image management module 144, and browsing module 147, the blogging module 142 may be used to send text, still images, video, and/or other graphics to a blog (e.g., the user's blog).

In conjunction with touch screen 112, display controller 156, optical sensor(s) 164, optical sensor controller 158, contact module 130, graphics module 132, and image management module 144, the camera module 143 may be used to capture still images or video (including a video stream) and store them into memory 102, modify characteristics of a still image or video, or delete a still image or video from memory 102.

In conjunction with touch screen 112, display controller 156, contact module 130, graphics module 132, text input module 134, and camera module 143, the image management module 144 may be used to arrange, modify or otherwise manipulate, label, delete, present (e.g., in a digital slide show or album), and store still and/or video images.

In conjunction with touch screen 112, display controller 156, contact module 130, graphics module 132, audio circuitry 110, and speaker 111, the video player module 145 may be used to display, present or otherwise play back videos (e.g., on the touch screen or on an external, connected display via external port 124).

In conjunction with touch screen 112, display system controller 156, contact module 130, graphics module 132, audio circuitry 110, speaker 111, RF circuitry 108, and browser module 147, the music player module 146 allows the user to download and play back recorded music and other sound files stored in one or more file formats, such as MP3 or AAC files.

In conjunction with RF circuitry 108, touch screen 112, display system controller 156, contact module 130, graphics module 132, and text input module 134, the browser module 147 may be used to browse the Internet, including searching, linking to, receiving, and displaying web pages or portions thereof, as well as attachments and other files linked to web pages.

In conjunction with RF circuitry 108, touch screen 112, display system controller 156, contact module 130, graphics module 132, text input module 134, e-mail module 140, and browser module 147, the calendar module 148 may be used to create, display, modify, and store calendars and data associated with calendars (e.g., calendar entries, to do lists, etc.).

In conjunction with RF circuitry 108, touch screen 112, display system controller 156, contact module 130, graphics module 132, text input module 134, and browser module 147, the widget modules 149 are mini-applications that may be downloaded and used by a user (e.g., weather widget 149-1, stocks widget 149-2, calculator widget 149-3, alarm clock widget 149-4, and dictionary widget 149-5) or created by the user (e.g., user-created widget 149-6). A widget may include an HTML (Hypertext Markup Language) file, a CSS (Cascading Style Sheets) file, and a JavaScript file. A widget may also include an XML (Extensible Markup Language) file and a JavaScript file (e.g., Yahoo! Widgets).

In conjunction with RF circuitry 108, touch screen 112, display system controller 156, contact module 130, graphics module 132, text input module 134, and browser module 147, the widget creator module 150 may be used by a user to create widgets (e.g., turning a user-specified portion of a web page into a widget).

In conjunction with touch screen 112, display system controller 156, contact module 130, graphics module 132, and text input module 134, the search module 151 may be used to search for text, music, sound, image, video, and/or other files in memory 102 that match one or more search criteria (e.g., one or more user-specified search terms).

In conjunction with touch screen 112, display controller 156, contact module 130, graphics module 132, and text input module 134, the notes module 153 may be used to create and manage notes, to do lists, and the like.

In conjunction with RF circuitry 108, touch screen 112, display system controller 156, contact module 130, graphics module 132, text input module 134, GPS module 135, and browser module 147, the map module 154 may be used to receive, display, modify, and store maps and data associated with maps (e.g., driving directions; data on stores and other points of interest at or near a particular location; and other location-based data).

In conjunction with touch screen 112, display system controller 156, contact module 130, graphics module 132, audio circuitry 110, speaker 111, RF circuitry 108, text input module 134, e-mail client module 140, and browser module 147, the online video module 155 allows the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In other modes of operation, instant messaging module 141, rather than e-mail client module 140, is used to send a link to a particular online video.

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. For example, video player module 145 may be combined with music player module 146 into a single module (e.g., video and music player module 152, FIG. 2). Memory 102 may store a subset of the modules and data structures identified above. Furthermore, memory 102 may store additional modules and data structures not described above.

The device 100 may be a device where operation of a predefined set of functions on the device is performed exclusively through a touch screen 112 and/or a touchpad. By using a touch screen and/or a touchpad as the primary input/control device for operation of the device 100, the number of physical input/control devices (such as push buttons, dials, and the like) on the device 100 may be reduced.

In other embodiments, a computer may be used to run the applications of the present disclosure. The various embodiments and/or components, for example, the modules, elements, or components and controllers therein, may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), field-programmable gate arrays (FPGAs), graphical processing units (GPUs), logic circuits, and any other circuit or processor capable of executing the functions described herein. The above examples are exemplary only, and are thus not intended to limit in any way the definition and/or meaning of the term “computer.”

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software”, “firmware” and “algorithm” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

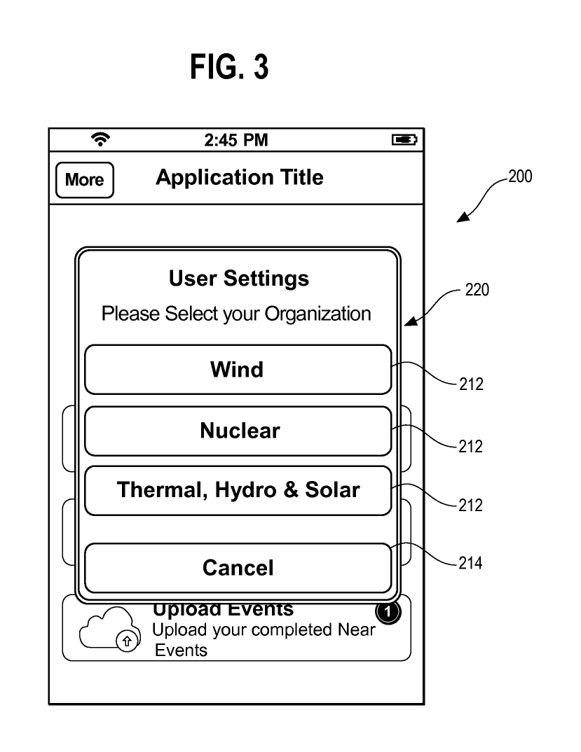

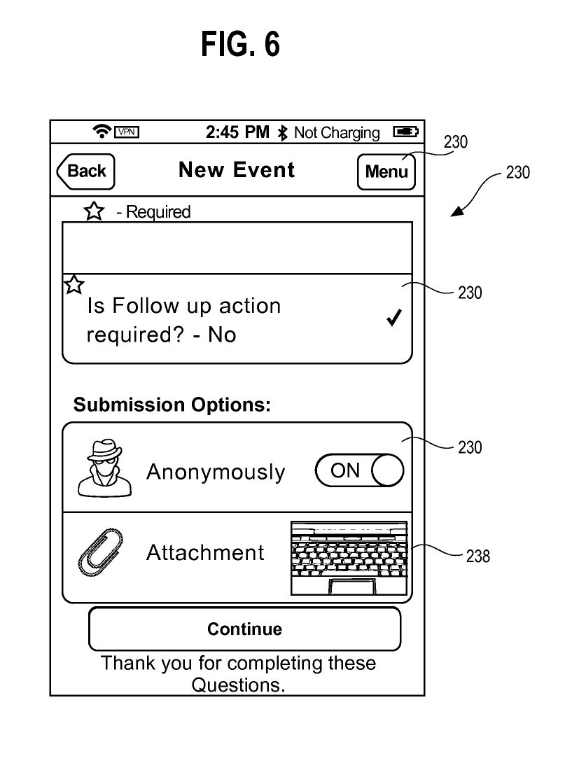

In reference to FIGS. 3-13, various embodiments of graphical user interfaces are illustrated for embodiments of a computer software application 200 operating on an embodiment of device 100. The interface, which may be but is not necessarily graphical, may be displayed on screen 112 and a user of the application may operate embodiments of the software application 200 described herein using previously described controls and features of device 100.

FIG. 3 illustrates an example user identification screen 210. In one embodiment of application 200, the identification screen 210 may be the initial interface for the user upon launch of the application. At user identification screen 210, a user may be prompted to select a user category 212. For instance, where a user may be employed on behalf of multiple organizations, such as an independent contractor, a user category 212 may be the organization employing the user during the user's field reporting of a near miss event. As another example, user category 212 may be the particular department which will be reviewing the user's field report. A user category cancel feature 214 may be included in order to permit the user to proceed without requiring a selection of user category 212.

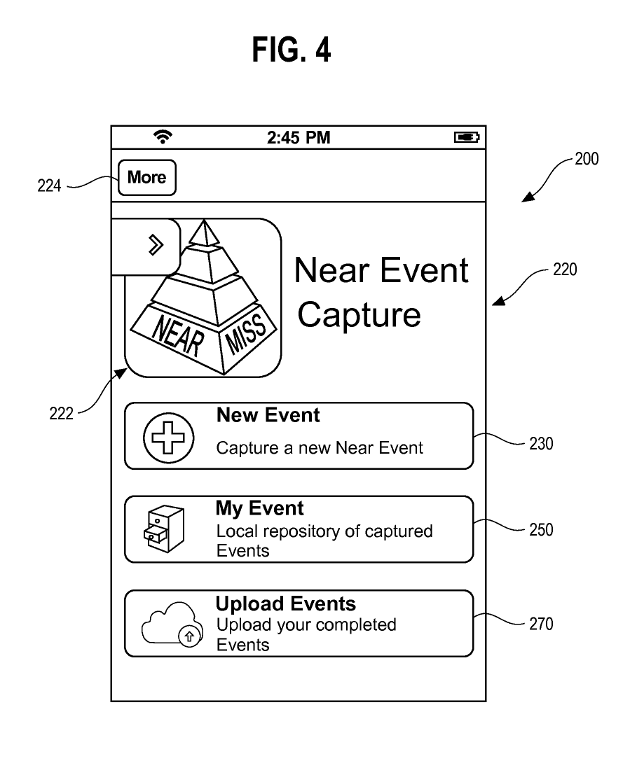

FIG. 4 illustrates an example home screen 220 for an embodiment of application 200. At home screen 220, a home screen graphic 222 may be provided along with one or more activity options. In the illustrated embodiment, the activity options include documenting a new event 230, reviewing previously documented events 250, and communicating documented events 270. It should be understood and appreciated that additional activities relating to the documentation or reporting of the events by a user are contemplated within the disclosure. While certain user activities may be classified as a primary activity, such as documenting 230, reviewing 250, and communicating activities 270 in the illustrated embodiment, additional secondary activities may be included as part of application 200. These secondary activities may be toggled through a “more” button 224, which in one embodiment may provide a drop-down list of secondary activities. Secondary activities may include reviewing documented events reported from other devices or other users as well as coordinating servicing of facilities based on reported events and inspections scheduled for said events.

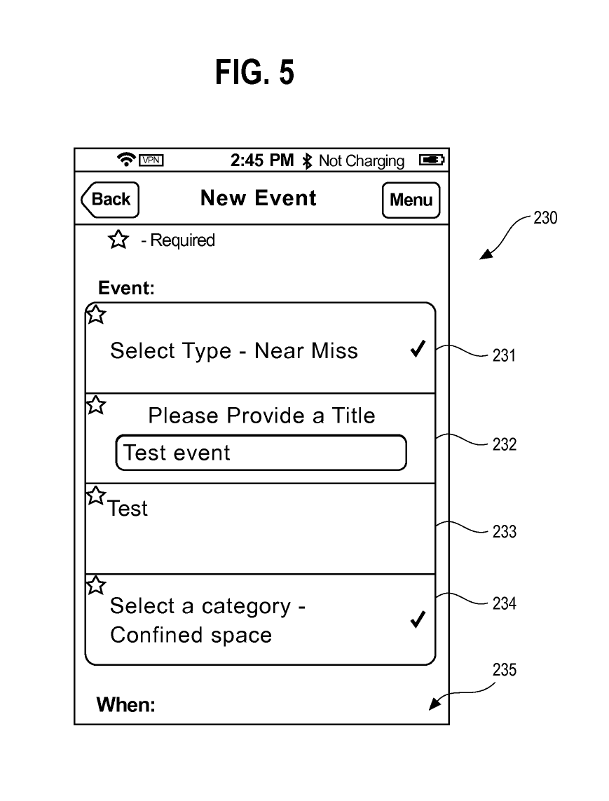

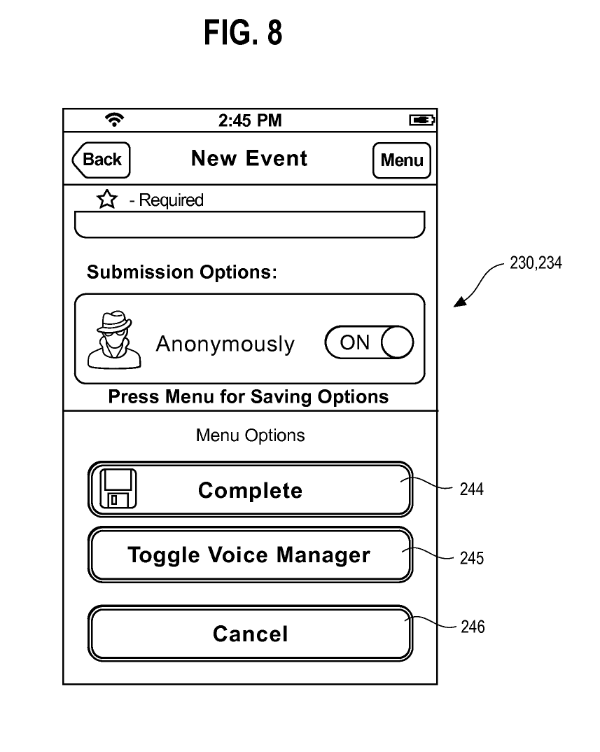

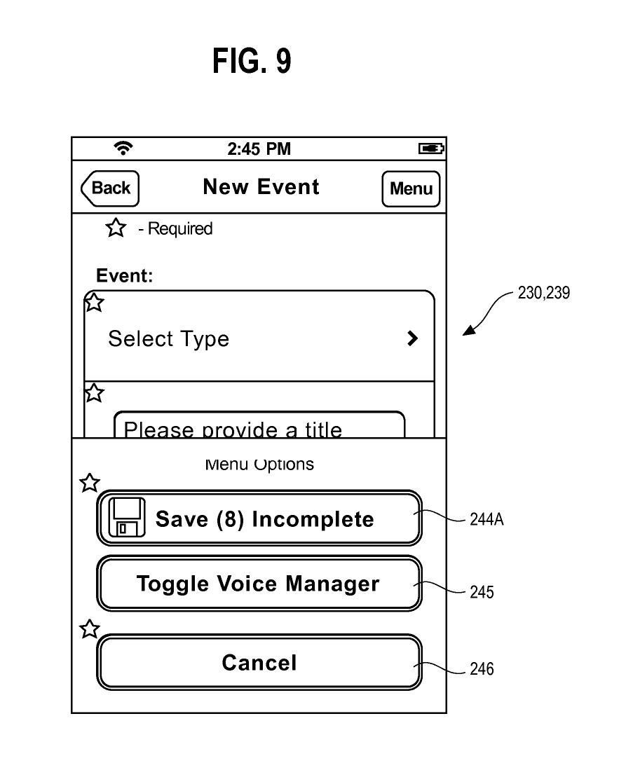

FIGS. 5-10 illustrate an example interface for documenting a new event 230 in accordance with embodiments of application 200. Initially with reference to FIGS. 5-7, a variety of fields for collecting new event information may include event type 231, event title 232, event commentary 233, event category 234, event occurrence date 235, event follow up selection 236, anonymous selection 237, and file attachment 238. Other fields may be included which may provide information regarding a “near miss event” or other maintenance observations. A menu button 239 may also be provided, from which additional options may be available such as saving the new event 230 data, as described in the embodiments illustrated in FIGS. 8-9 and further described herein.

In one embodiment, a user may select the event type 231 from a predetermined list of types of events. “Unsafe condition” and “near miss” are two example types of events. A user may then input a title 232 of event. Additional notes or commentary 233 regarding the event may also be inputted. The user may then select an appropriate category 234 of event. Example categories may be “confined space” or “structural.” Event categories 234 together with event types 231 may be pre-selected in order to assist with report generation and data organization, further described herein. An event date 235, which may include both date and time, may be manually inputted or automatically generated as a timestamp from device 100. Binary selections may also be provided, such as whether follow up 236 is required, and whether the report should be sent anonymously 237. The follow up selection 236 may assist administrators of application 200 to prioritize subsequent maintenance schedules for the facility. The anonymous feature may allow a user to report the event anonymously, which the user may prefer for a variety of reasons such as political sensitivities within the user's company. Files or data may also be attached 238 as part of the new event documentation. The file may be generated from data collected from device 100, such as a photo or sound recording of the observed event. In order to encourage users to utilize application 200 in their documentation efforts, it may be advisable to keep the number of fields to a minimum thereby simplifying the documentation 230 process.

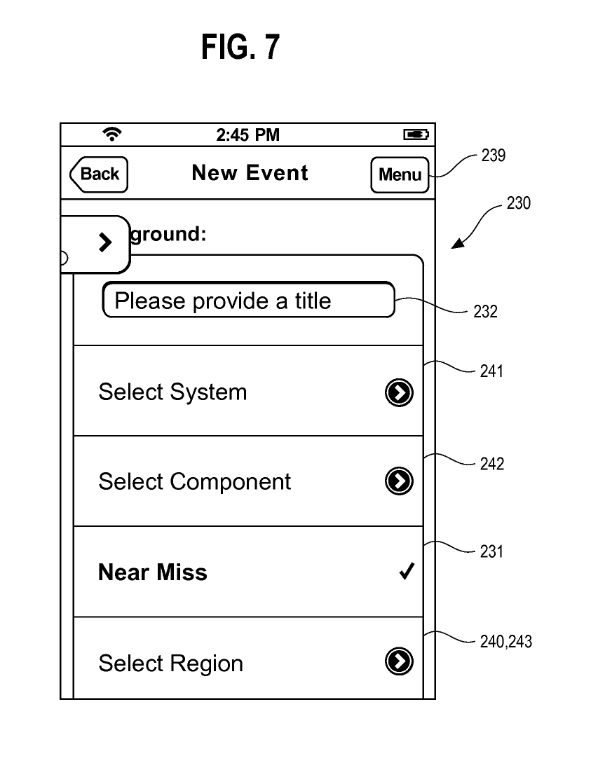

FIG. 7 illustrates another embodiment of a user interface for documenting a new event 230. As illustrated in this embodiment, location 240 is an additional field which may be included. Location 240 may be manually inputted by the user, or in another embodiment location 240 may be inputted using location determining features of device 100, such as GPS module 135. Additionally shown in this embodiment is that additional fields may be selected from a pre-determined list of fields, such as a system 241 affected by the event, a component 242 affected by the event, or a region 240/243 where the event occurred. Another potential field entry is potential injury information where a user would select, or manually input, the type of injury that could occur from a catastrophic event resulting from the “near miss” event observed. A still further potential field entry is action taken, whereby the user may select, or manually input, the type of action taken as a result of observing the event. One such selection may be follow up 236.

FIGS. 8-9 illustrate interface embodiments for saving data associated with new event 230. In one embodiment, the save or record option may be available via menu button 239. Upon entry of all required data and optional data, the user may then have the option to save the data locally within device 100. Saving may be initiated through a save button 244. As previously described, some fields may be labelled as required or optional. Should a user complete a subportion of the required fields, the save button 244 may include a missing field prompt 244A. Even if there are missing fields, the user may still locally save the event data and return to the event to entry to finish inputting the data. An additional feature is a voice manager 245. Voice manager may utilize components of device 100 to permit voice recordation of data for input into one of the fields, or as an additional file attachment 238. A cancel button 246 may also be provided should a user wish to exit the menu 239 or cancel one of the features which the user may have originally activated.

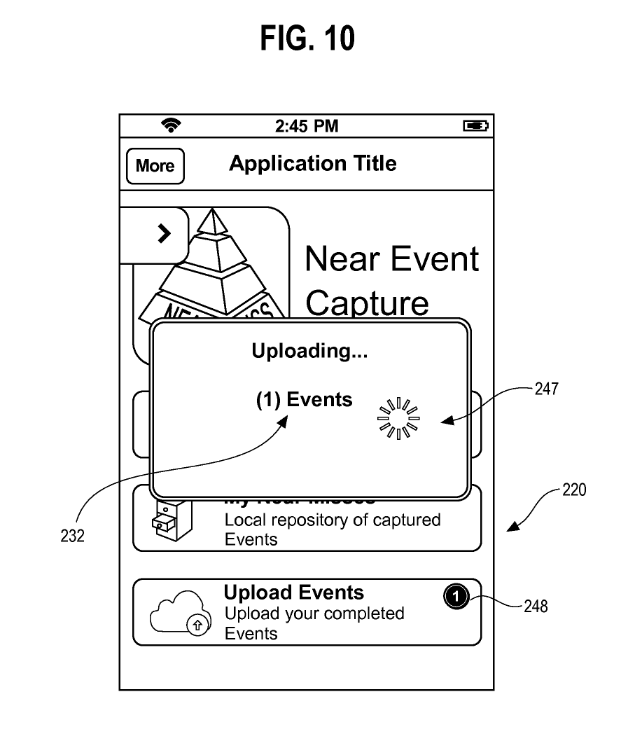

Once the data for a new event 230 is inputted, it may be saved and/or transmitted to an administrator computer 300. FIG. 10 illustrates a user interface screen for transmission 247 of new event data. The transmission screen may include information about the new event, such event title 232, as well as a status bar. In one embodiment, the new event data may be first saved locally to device 100, such memory 102, or alternatively the data may immediately be transmitted to administrator computer 300, and for security purposes never actually stored on device 100. It should be understood that communication of new event data may occur by any components and circuitry described herein as part of device 100. It would also be understood by those of ordinary skill in the art that administrator computer 300 may be a central computer having any component, circuitry, or modules described herein with respect to mobile device 100. Central computer 300 may be a mobile device as well, or may be a stationary desktop computer. Central computer 300 may further include a server for coordinating communications with multiple devices 100 operated by user employees. Known or to be discovered authentication modules as well as known or to be discovered encryption modules, along with associated circuity and components, usable with either device 100 or central computer 300 are contemplated within the disclosure in order to ensure safe and reliable communication of data between device 100 and central computer 300.

New event data may be indicated on home screen 220 with an indicator 248, illustrated as in the background of transmission screen 247. Indicator 248 may appear, for instance, next to the button for uploaded events 270, and indicator 248 may indicate the number of recently uploaded new events, such as those events uploaded in the application's current session.

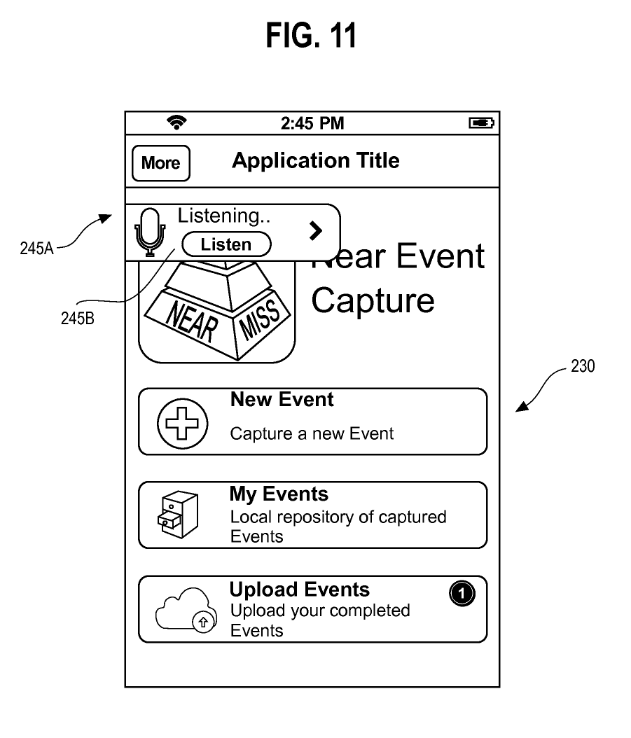

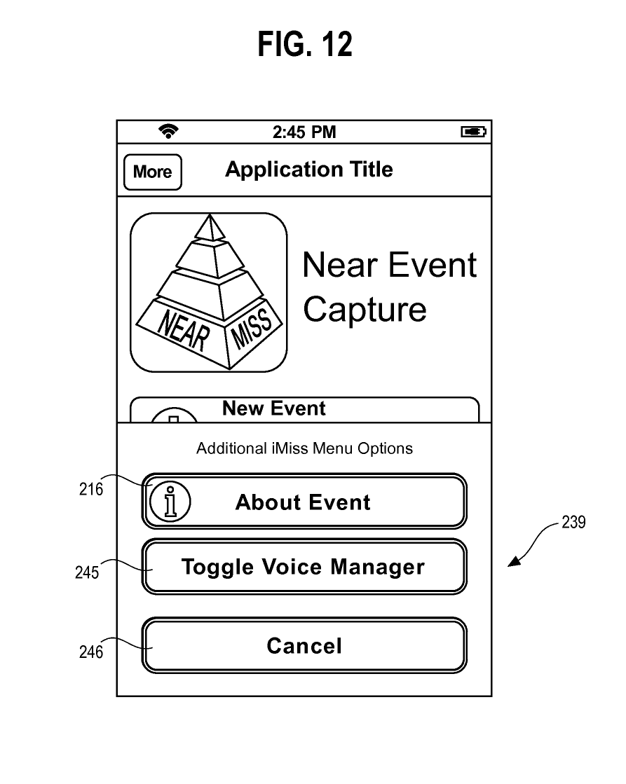

As illustrated in FIG. 11, should a user activate voice manager feature 245 a voice manager prompt 245A may appear indicating the application is actively collecting voice data. A voice activation button 245B may be included in the prompt. The application may then receive audible statements from the user. The voice recognition technology may, for instance, be programmed to recognize commands associated with various fields discussed herein, as well as typical answers including binary answers “yes” and “no” as well as free form answers such as body parts which may be injured if a catastrophic failure occurred, or possible event locations such as street names. FIG. 12 further demonstrates that in some embodiments, menu 239 is toggleable from a variety of areas within application 200 besides new event input 230. For instance, menu 239 may be toggled from home screen 220. In some embodiments menu 239 will include general information 216 about application 210, such as ownership, version, and production date.

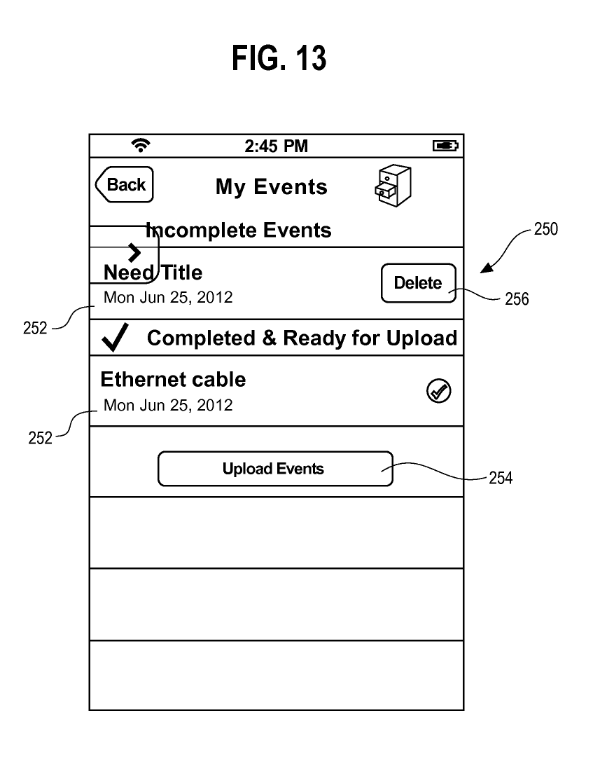

Referring now to FIG. 13, previously completed events may be viewable from a previously document events menu 250. A list of previously completed events 252 may be displayed for the user's review. The previously completed event 252 may be edited by the user through an interface similar to the interfaces illustrated and previously described. From this interface screen, and addition to reviewing the event 252, the user may have the option of uploading 254 or deleting 256 events. The connection method between device 100 and central computer 300 may be illustrated on this interface in order to report to the user how the event data was transmitted. Previously completed events 252 may be divided between incomplete events and completed events, with completed events eligible for transmission to central computer 300.

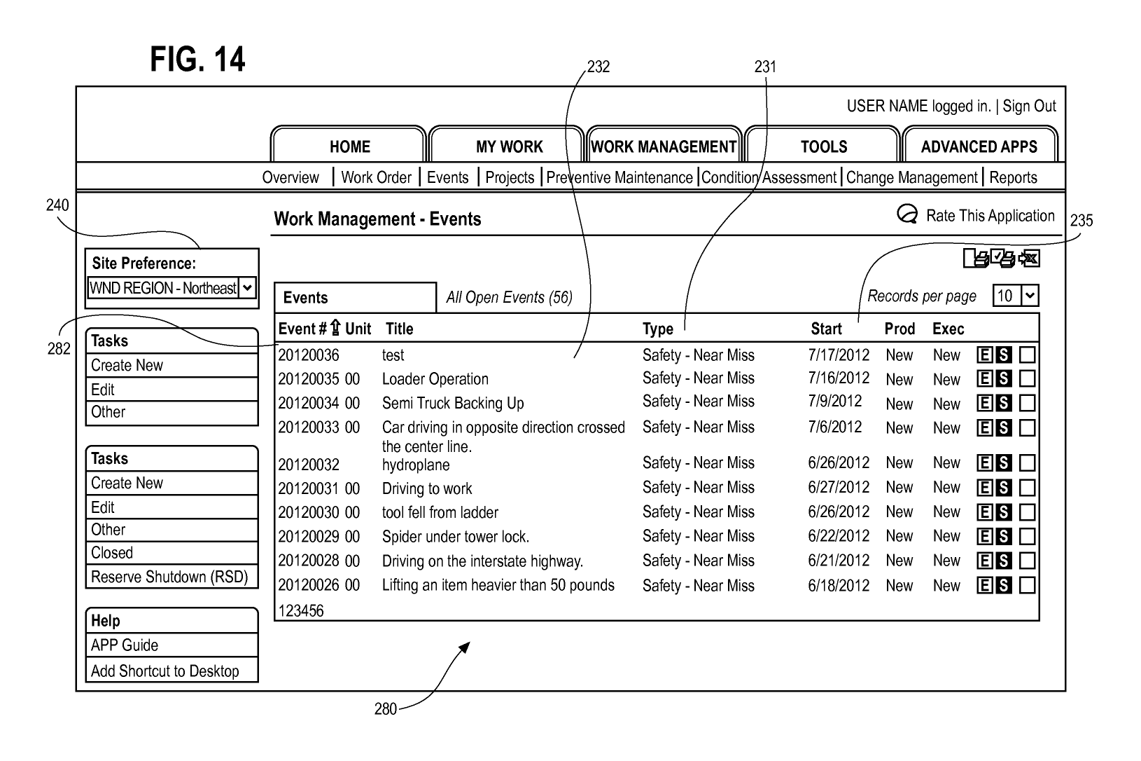

FIG. 14 illustrates an example report 280 which may be generated by application 200. The report 280 may be generated in a computer software program operating on central computer 300. Event data generated by the user on mobile device 100 may be categorized and displayed. A unique event number 282 may be assigned for each even submission. Information may be outputted in categorical or chart format. Report information may include: number of observations in a certain time period, number of observation by location, number of observations by category, number of events by severity, and number of events by injury type.

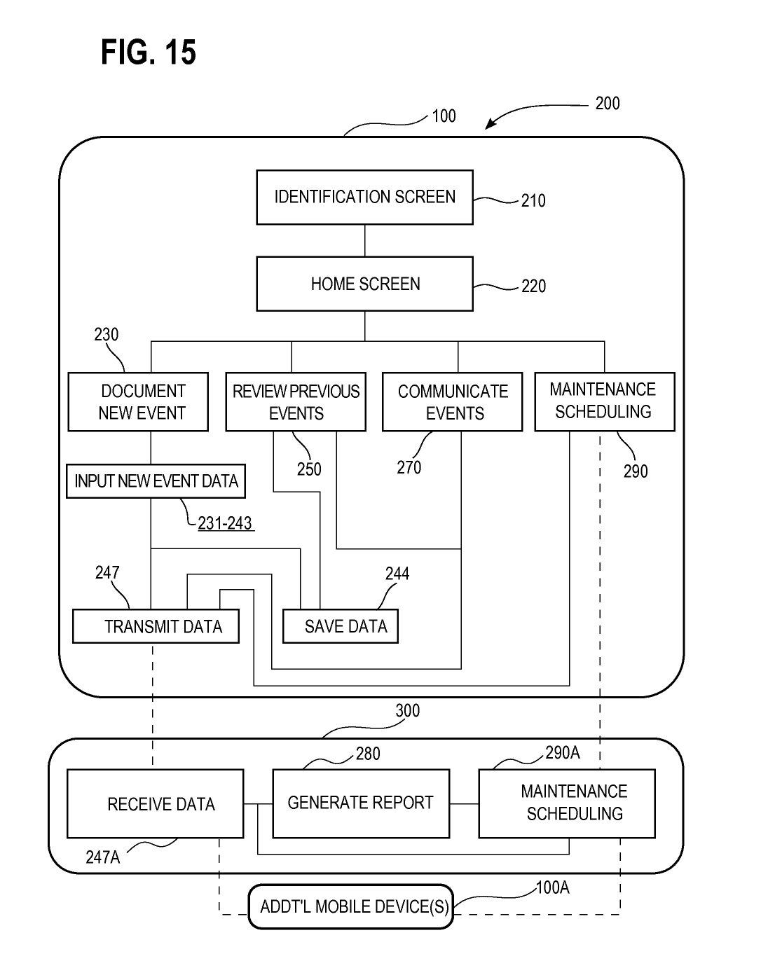

In reference now to FIG. 15, a schematic view of an embodiment of system architecture is illustrated as may be used with mobile device 100 and central computer 300. In the illustrated embodiment, mobile application 200 operates on mobile device 100 while a report generating module operates on central computer 300. It should be understood and appreciated, however, that the entirety of the system may operate on device 100. Additionally, in some embodiments a plurality of mobile devices including mobile device 100 and at least one additional mobile device 100A operate as part of system, with additional mobile device(s) 100A operating the same or similar application 200.

In accordance with the various embodiments of the disclosure, application 200 may include an identification screen 210, a home screen 220, documentation of new events 230, review of previously documented events 250, communication of events 270, and maintenance scheduling 290. In order to document new events observed by a user, event data may be inputted as described herein. The event data may then be saved 244 or transmitted 247 to a receiver 247A at central computer 300. The transmission may be by any method described herein, or to be developed. A user may also review previous event data 250, and may edit and save 244 said previous data or may proceed to transmit the data 247. Rather than reviewing the previous events, the user may proceed to directly communicate event data 270 to central computer 300. Upon receipt of the data 247A, central computer may then operate a scheduling module which may generate a report 280 and proceed with facility maintenance scheduling 290A.

With or without a generated report 280, central computer 300 may review and process event data resulting in scheduling maintenance for the user of mobile device 100, or alternatively another user which may be operating an additional mobile device 100A. Central computer 300 may transmit event data in order to facilitate maintenance follow up by the user. The user may access maintenance scheduling 290 from the mobile device 100 as part of application 200. As part of maintenance scheduling 290, the application 200 may utilize features of mobile device 100, such as GPS module 135, in order to guide the user to previously identified locations of previously observed and documented events. Further, maintenance scheduling 290, 290A may generate a service route for user of device 100. The service route may identify the events to be followed up on as part of the user's maintenance activities, and generate an efficient route for the user to accomplish the user's follow up observations and data collecting. Upon completing a follow up, maintenance data 290 may be transmitted 247 back to central computer 300 indicating status updates of the previously documented events. Service routes may be charted and observed in real-time by the mobile device 100, and may further transmit data 247 in real time to central computer 300 thereby permitting an administrator of the system to monitor progress of a user conducting his or her service route. An administrator may also observe follow up data collected on the previously documented event and provide maintenance instructions to the user on site. In this regard, and particularly in coordination with multiple users operating multiple mobile devices 100, 100A, the administrator may efficiently coordinate scheduled maintenance for variety of structures and facilities, which may require maintenance by multiple individuals which from a variety of organizations.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(F), unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed:

1. A system for reporting events or conditions of a facility, the system comprising:
a mobile device including a device processor, a device transmitter, and a device receiver; and
a central computer including a central processor, a central database, a central transmitter, and a central receiver,
wherein the mobile device collects event data inputted by a user of the mobile device and transmits the event data from the device transmitter to the central receiver,
wherein the central processor generates a report categorizing and describing the event data, and
the event data includes observations by the user of an event at the facility requiring maintenance of the facility.

2. The system of claim 1, wherein the event data includes whether the event requires follow up maintenance, and
wherein the central processor further generates a maintenance schedule which includes whether the event requires follow up maintenance, and transmits the maintenance schedule from the central transmitter to the device receiver.

3. The system of claim 2, wherein the maintenance schedule includes a plurality of events, and
wherein the device processor compares the location of each of the plurality of events requiring follow up maintenance and generates a service route for the user to follow in order for the user to efficiently observe each location of the plurality of events.

4. The system of claim 3, the mobile device further comprising a global positioning system (GPS) module, and
the device processor further identifies the location of the user and adjusts the generated service route based on the user's location.

5. The system of claim 1, further comprising an additional mobile device having a second device processor, a second device transmitter, and a second device receiver,
wherein the additional mobile device also collects event data inputted by an additional user of the additional mobile device and transmits the event data from the second device transmitter to the central processor.

6. The system of claim 5, wherein the event data includes whether the event requires follow up maintenance,
wherein the central processor further generates a maintenance schedule which includes a plurality of events requiring follow up maintenance, and transmits the maintenance schedule from the central transmitter to the device receiver and the second device receiver, and
wherein the device processor and the second device processor each respectively compares the location of the each of the plurality of events requiring follow up maintenance and generates a service route for the users to follow in order for the users to efficiently observe each location of the plurality of events.

7. The system of claim 6, wherein the mobile device further includes a global positioning system (GPS) module and the additional mobile device further includes a second global positioning system (GPS) module, and
wherein the device processor further identifies the location of the user of the mobile device and the second device processor further identifies the location of the user of the second mobile device, and the device processor and second device processor each adjust the service routes based on each user's location.

8. The system of claim 7, wherein the adjusted service routes are transmitted to the central processor, which compares the adjusted service route of the first user with the adjusted service route of the second user, determines if there is any overlap between the adjusted service routes, corrects each of the adjusted service routes if there is overlap, and transmits the corrected routes to the mobile device and the additional mobile device.

9. A non-transitory computer-readable medium within a mobile device for reviewing conditions of a facility, comprising instructions stored thereon, that when executed on a processor, perform the steps of:
collecting information about an event associated with the facility, the information including the type of event, the location of the event, when the event occurred, and whether follow up action is required;
storing the information in a database provided in the mobile device; and
transmitting the information from a transmitter provided in the mobile device to a receiver provided in a central computer processing unit.

10. The non-transitory computer-readable medium of claim 9, wherein the information further includes an attachment file of a picture of the event.

11. The non-transitory computer-readable medium of claim 9, wherein the information is collected from a user of the mobile device audibly inputting the data with a voice manager.

12. The non-transitory computer-readable medium of claim 9, wherein the information further includes user identification information, and a user of the mobile device may elect to transmit the information anonymously.

13. The non-transitory computer-readable medium of claim 9, wherein the event is an unsafe condition at the facility.
